(19) United States
(12) Patent Application Publication
(10) Pub. No.: US 2017/0275769 A1
(43) Pub. Date: Sep. 28, 2017

(54) METHOD FOR MANUFACTURING TUBULAR CO-ELECTROLYSIS CELL

(71) Applicant: KOREA INSTITUTE OF ENERGY RESEARCH, Daejeon (KR)

(72) Inventors: Tak-hyoung LIM, Daejeon (KR); Rak-hyun SONG, Seoul (KR); Seok-joo PARK, Daejeon (KR); Seung-bok LEE, Daejeon (KR); Jong-won LEE, Daejeon (KR)

(73) Assignee: KOREA INSTITUTE OF ENERGY RESEARCH, Daejeon (KR)

(21) Appl. No.: 15/129,660

(22) PCT Filed: Apr. 30, 2015
(86) PCT No.: PCT/KR2015/004371

§ 371 Date: Sep. 27, 2016

(30) Foreign Application Priority Data
Dec. 18, 2014 (KR) 10-2014-0183144

(51) Int. Cl. C25B 9/12; H01M 8/12; B01J 19/08; H01M 8/02; H01M 8/10; C25B 1/02; B01D 53/32; B01D 53/62

(52) U.S. Cl. CPC C25B 9/12; B01D 53/32; H01M 8/12; B01D 53/62; H01M 8/02; H01M 8/10; C01B 31/18; C25B 1/02; B01J 19/08

(57) ABSTRACT

The present invention relates to a method for manufacturing a tubular co-electrolysis cell which is capable of producing synthesis gas from water and carbon dioxide, and a tubular co-electrolysis cell prepared by the preparing method. The present invention comprises a tubular co-electrolysis cell which comprises: a cylindrical support comprising NIO and YSZ: a cathode layer formed on a surface of the cylindrical support, the cathode layer comprising (Sr₁₋ₓLaₓ)Ti_{1-y}M_{y})O₃(M=V, Nb, Co, Mn); a solid electrolyte layer formed on the surface of the cathode layer; and an anode layer formed on a surface of the solid electrolyte layer. The tubular co-electrolysis cell manufactured by the method for manufacturing the tubular co-electrolysis cell of the present in has an excellent synthesis gas conversion rate and is capable of producing synthesis gas even at a low over voltage.

### CROSS-REFERENCE TO RELATED APPLICATIONS

This patent application is a national stage application of PCT application No. PCT/KR2015/004371 filed on Apr. 30, 2015 claiming priority under 35 U.S.C. §119 to Korean Patent Application No. 10-2014-0183144, filed on Dec. 18, 2014, in the Korean Intellectual Property Office, the disclosures of which are incorporated by reference herein in their entireties.

### TECHNICAL FIELD

The present invention relates to a method for preparing a tubular co-electrolysis cell, and more specifically to, a method for preparing a tubular co-electrolysis cell capable of producing syngas from water and carbon dioxide, and a tubular co-electrolysis cell prepared by the preparing method.

### DISCUSSION OF RELATED ART

Various policies have been suggested to reduce carbon emissions in the world according to the Kyoto Protocol adopted in 1997, and techniques of reducing the generation of carbon dioxide have been developed in various aspects.

In an aspect to develop a fuel that does not emit carbon dioxide in order to essentially prevent release of carbon dioxide, techniques for generating electricity by having a hydrogen fuel react with oxygen in the air have been developed, and vehicles utilizing motors using hydrogen as a fuel are widely known.

On the other hand, there is ongoing research and development related to the process of converting to a usable fuel by using carbon dioxide previously generated. More attention is directed to production of hydrogen by CO₂-based high-temperature electrolysis as well as recent green enemy technologies and renewable energy research and development.

A high temperature electrolysis system is an apparatus to inject carbon dioxide and steam to a cathode and air to an anode, and to produce syngas by electrolysis reaction when applying electricity while maintaining a high temperature. Although the technology to produce syngas by CO₂-H₂O high temperature electrolysis reaction improves reaction efficiency by combining reaction and separation processes to allow for a simplified process and increased throughput that leads to an efficient operation, high temperature electrolysis technology of carbon dioxide has been limitedly developed in the research focusing on noble metal electrodes.

Further, the co-electrolysis cell to produce syngas by CO₂-H₂O high temperature electrolysis has a problem with commercialization due to a low syngas conversion rate of CO₂ and poor efficiency. Thus, a need exists for a co-electrolysis cell with a good conversion rate as compared with those adopted in a conventional high temperature electrolysis reaction system.

### SUMMARY

An object of the present invention is to provide a method for preparing a tubular co-electrolysis cell having an excellent syngas conversion rate.

Further, an object of the present invention is to provide a method for preparing a tubular co-electrolysis cell having a low overvoltage to produce syngas.

In order to achieve the above object, the present invention is to provide a tubular co-electrolysis that comprises a cylindrical support including NIO and YSZ, a cathode layer comprising (Sr₁₋ₓLaₓ)(Ti_{1-y}M_{y})O₃(M=V, Nb, Co, Mn) formed on a surface of the cylindrical support, a solid electrolyte layer formed on a surface of the cathode layer, and an anode layer formed on surface of the solid electrolyte layer.

The solid electrolyte layer may comprise GDC (gadolinium-doped ceria), and the anode layer may comprise a LSCF-GDC.

A fuel used in the cathode layer may comprise H₂O, CO₂ and H₂.

Further, the present invention is to provide a method for preparing a tubular co-electrolysis cell that comprises a step 1 of mixing NIO, YSZ, and a pore forming agent, mixing with a solvent into a type of slurry, and ball-milling the slurry, a step 2 of drying and then powdering the slurry, a step 3 of producing a support for the co-electrolysis cell by adding an additive to the powdered mixture and kneading to produce a paste, and extracting the paste, a step 4 of rolling-drying the extruded support for the co-electrolysis cell, and a step 5 of pre-sintering the rolling-dried support for the co-electrolysis cell and then coating the support with a cathode, an electrolyte, and an anode, and the cathode comprises a (Sr₁₋ₓLaₓ)(Ti_{1-y}M_{y})O₃(M=V, Nb, Co, Mn).

The pore forming agent may comprise active carbon or carbon black. The additive may comprise a binder, a plasticizer, and a lubricant.

The pre-sintering can be performed by stepwise-heating eluding up to 300° C. to 400° C., then to 700° C. to 800° C., and then 1000° C. to 1200° C.

The cathode and the anode may be coated by dip coating.

The cathode may be coated and then thermally treated at 800° C. to 1200° C. The anode may be coated and then thermally treated at 900° C. to 1400° C.

The electrolyte may be coated by vacuum slurry coating.

The electrolyte may be coated and then thermally treated at 1200° C. to 1600° C.

A fuel used in the cathode can comprises H₂O, CO₂ and H₂.

Further, the present invention is to provide a tubular co-electrolysis cell prepared by the methods and a tubular cell-based co-electrolysis module comprising the tubular co-electrolysis cell.

A tubular co-electrolysis cell prepared by the method for preparing a tubular co-electrolysis cell of the present invention has an excellent conversion rate.

A tubular co-electrolysis cell prepared by the method for preparing a tubular co-electrolysis cell of the present invention can provide syngas at a low overvoltage.

### BRIEF DESCRIPTION OF THE DRAWINGS

FIG. 1 is a view illustrating a mixture process of step 1 according to the present invention:

FIGS. 2 and 3 are views respectively illustrating kneading a mixture and extruding a paste of step 3 according to the present invention;

FIGS. 4 and 5 are views illustrating drying and pre-sintering an extruded support for a co-electrolysis cell of step 4 according to the present invention;

FIGS. 6 to 8 are views illustrating the process of coating a cathode and then an electrolyte and anode of step 5 according to the present invention;

FIG. 9 is a view illustrating a reduction process for a tubular co-electrolysis cell prepared by step 5 of the present invention;

FIG. 10 is a view illustrating a prepared tubular co-electrolysis cell;

FIG. 11 is a cross-sectional view of a tubular co-electrolysis cell;

FIG. 12 is a view illustrating an atmospheric-pressure, high-temperature co-electrolysis module including a tubular co-electrolysis cell; and

FIG. 13 is a graph illustrating a result of operation of an atmospheric-pressure, high-temperature co-electrolysis module.

### EXEMPLARY EMBODIMENTS

Hereinafter, the present invention will be described in detail with reference to the accompanying drawings. The terms or words used in the present invention should not be limited as construed in typical or dictionary meanings, but rather to comply with the technical concept of the present invention.

According to an embodiment of the present invention, a tubular co-electrolysis cell comprises a cylindrical support including NIO and YSZ, a cathode layer formed on surface of the cylindrical support, a solid electrolyte layer formed on the cathode layer, and an anode layer formed on the solid electrolyte layer.

A co-electrolysis cell is an apparatus to produce syngas by electrolysis occurring when applying electricity while maintaining a high temperature, with carbon dioxide and steam injected into a cathode and air into an anode. Such co-electrolysis cell is a new renewable energy generating apparatus capable of obtaining a reusable fuel from carbon dioxide.

The support may be, but n not limited to, a cermet of NIO and YSZ that are respectively nickel (NIO)/yttria stabilized zirconia (YSZ).

The cathode may be, but is not limited to, a Nl-YSZ of metal-ceramic complex, a LSCM ((La_{0.75}, Sr_{0.25})_{0.95}Mn_{0.5}, Cr_{0.5}O₃) as a perovskite-type ceramic cathode, or a (Sr₁₋ₓLaₓ)(Ti_{1-y}M_{y})O₃ (M=V, Nb, Co, Mn) as a LST-type ceramic cathode.

In particular, it is preferred to use (Sr₁₋ₓLaₓ)(Ti_{1-y}M_{y})O₃ (M=V, Nb, Co, Mn) as the cathode. As a LST type ceramic cathode. (Sr₁₋ₓLaₓ)(Ti_{1-y}M_{y})O₃ (M=V, Nb, Co, Mn) may constantly maintain conductivity and mechanical strength because it does not generate redox cycling due to excellent redox resistance even at a high concentration of H₂O in fuel.

As the anode, one typically well-known in the art to which the present invention pertains may be used, including e.g., a LSCF-GDC, YSZ/LSM and LSM composite, without limited thereto.

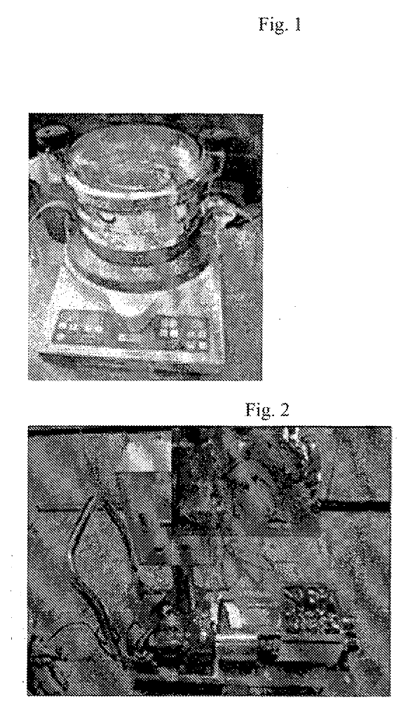

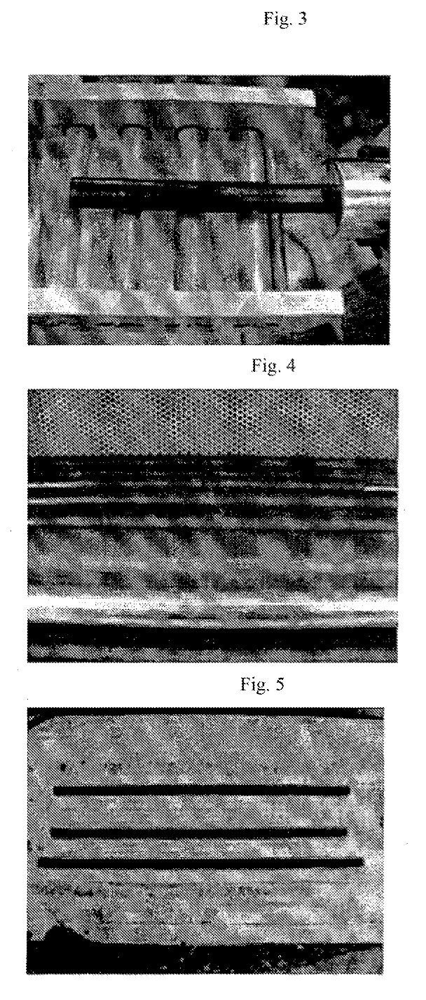

FIG. 1 illustrates a mixing process of step 1. FIGS. 2 and 3 respectively illustrate the process of kneading a mixture and the process of extruding a paste of step 3 according to the present invention. FIG. 4 illustrates a rolling-drying process of an extruded support for a co-electrolysis cell of step 4.

Step 1 is the step of mixing materials to produce a support to be used in a tubular co-electrolysis cell according to the present invention. Step 1 comprises mixing NIO, YSZ, and a pore forming agent and then ball-milling the mixture. The mixing process is illustrated in FIG. 1.

NIO and YSZ may be a cermet of nickel (NIO) yttria stabilized zirconia (YSZ). The pore forming agent enables the support to be porous, and carbon black, activated carbon, etc. can be used as the pore forming agent.

A mixture of NIO, YSZ and active carbon or carbon black can be ball-milled to thus be uniformized, and for increased uniformity, it may be ball-milled in slurry type formed by adding ethanol as a solvent.

Here, the pore forming agent is preferably included in 3 parts by weight to 10 parts by weight relative to NIO and YSZ that is of row powder.

The mixture produced in step 1 is dried in a dryer (hot plate) and screened (Step 2).

The drying process may be performed for 12 hours to 48 hours at 80° C. to 100° C.

Screening is a process for selecting a powder with a uniform particle size from the mixture having particles with different sizes by sieving the mixture using preferably a sieve with 80-mesh to 120-mesh.

Thereafter, an additive is added to the mixture powder produced in step 2 that is then knead to prepare a paste, and the paste is extruded into a support for co-electrolysis cell (Step 3).

A paste can be produced by kneading the mixture powder with the additive, and a co-electrolysis can be prepared by extruding the paste (Step 3).

The additive may include a binder, a plasticizer, and a lubricant. Ones well-known in the art to which the present invention pertains can be used as the binder, plasticizer, and lubricant, respectively. For example, methyl cellulose, hydroxypropyl methyl cellulose, etc. may be used as the binder. Propylene carbonate, polyethyleneglycol, dibutyl phthalate, etc. may be used as the plasticizer. Stearic acid may be used as the lubricant.

15 to 20 parts by weight of the binder are added relative to 100 parts by weight of a NIO, YSZ mixture powder that is a raw powder. When the content of the binder is less than 15 parts by weight, formability and pore formation raw of the support of the co-electrolysis cell may be decreased. When the content of the binder is more than 20 parts by weight, the strength of the support may be reduced and cracks may occur during the sintering process since excessive pores are created.

Preferably, 4 parts by weight to 8 parts by weight of the plasticizer are added with respect to 100 parts by weight of the NIO, YSZ mixture powder that is the raw powder. When the content of the plasticizer is less than 4 parts by weight, the extrusion may be deformed or cracked. When the content of the plasticizer is more than 8 parts by weight, the extrusion may be bent due to an excessive increase in ductility after sintering.

Preferably 2 parts by weight to 6 parts by weight of the lubricant are added relative to 100 parts by weight of the mixture powder of NIO and YSZ that is the raw powder. When the content of the lubricant is less than 2 parts by weight, the surface of the extrusion may peel off. When the content of the lubricant is more than 6 parts by weight, a stripe pattern may be left on the surface of the extrusion due to adhesion between a mold and the extrusion.

FIG. 2 illustrates a process of adding the additive to the mixture powder prepared in step 2 and kneading the same. FIG. 3 illustrates a process of preparing a tubular support by extruding, the kneaded paste.

In step 3, a prepared tubular support is rolling-dried and pre-sintered to minimize damage to its surface (Step 4).

FIG. 4 illustrates a rolling-drying process and FIG. 5 illustrates a pre-sintering process. The pre-sintering process is preferably performed by stepwise-heating.

Specifically, the pre-sintering process may include heating the tubular support prepared in step 3 for 8 hours to 12 hours, maintaining the support at 300° C. to 400° C. for 3 hours to 7 hours, heating it for 3 to 7 hours, and maintaining the support at 700° C. to 800° C. for 2 hours to 4 hours. Further, the pre-sintering process may include heating the support for 3 hours to 7 hours, and maintaining the support at 1000° C. to 1200° C. for 2 hours to 4 hours.

If the pre-sintering process is performed by heating up the support to 1000° C. to 1200° C. Immediately, not stepwise, then pores may abruptly be formed by a pore forming agent, causing cracks and resulting in the support being less durable.

Next, the cathode, electrolyte, and anode are sequentially coated on the support for a co-electrolysis cell pre-sintered in step 4 (Step 5).

The cathode that may be used in the co-electrolysis cell may include Nl-YSZ that is a metal-ceramic composite, LSCM (La_{0.75}, Sr_{0.25})_{0.95}Mn_{0.5}, Cr_{0.5}O₃) as a perovskite-type ceramic cathode, or a (Sr₁₋ₓLaₓ)(Ti_{1-y}M_{y})O₃ (M=V, Nb, Co, Mn) as a LST-type ceramic cathode.

In particular, (Sr₁₋ₓLaₓ)(Ti_{1-y}M_{y})O₃ (M=V, Nb, Co, Mn) that is of a LST-type ceramic cathode is preferably used as the cathode because the LST type ceramic cathode is not oxidized and its properties are not deteriorated even not satisfying a flow of hydrogen or a CO reducing gas.

In other words, the LST type ceramic cathode does not generate redox cycling due to excellent redox, resistance even when the fuel contains a high concentration of H₂O, allowing the electric conductivity and mechanical strength to remain constant.

Meanwhile, if a cathode has a P-based conduction mechanism in which electric charges move via holes, a strong reduction potential is derived, resulting m a resistance that polarizes an electrode. In other words, the cathode with the P type conduction mechanism has a short lifespan because it may be prone to damage that may occur from chemical or structural changes in the cathode.

However, a LST-type ceramic cathode has a N-type conduction mechanism in which negative electric charge free electron carriers induce an electric current, thus presenting a relatively stable behavior under a reduction condition without causing electrode polarization. Thus, the LST-type ceramic cathode, when used as a cathode for a co-electrolysis cell, may exhibit an excellent lifetime and electrode properties.

There may be added a process for enhancing the activity of the surface of the cathode to allow the cathode increased chemical or electrochemical reaction efficiency.

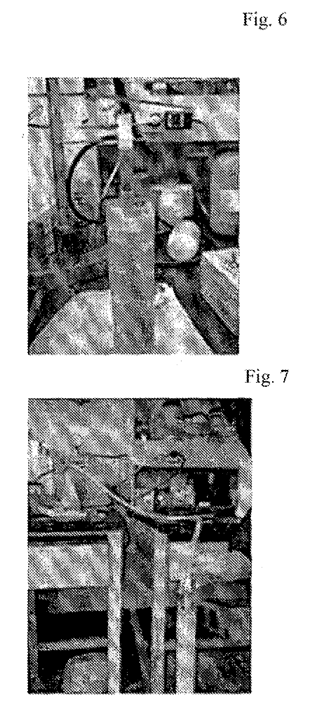

As shown in FIG. 6, the process of coating the cathode on the support may be performed by dip coating process. There may be further included, after the coating process, a heating process at 80° C. to 120° C. followed by a thermal-treating process at 800° C. to 1200° C. for 2 hours to 3 hours. A cooling process may further be performed at 200° C. to 300° C. after the thermal-treating process.

As the electrolyte, an electrolyte well known in the art to which the present invention pertains may be used. For example, yttria stabilized zirconia powder (YSZ powder), Sr- and Mg-doped lanthanum gallate powder (LSGM powder), scandia stabilized zirconium oxide powder (ScSZ powder), gadolinium-doped ceria powder (GDC powder), samaria-doped ceria powder (SDC powder), etc. may be, without limited thereto, used, and the electrolyte may be coated by vacuum slurry coating.

As shown in FIG. 7, there may further be included the steps of, after coating the electrolyte on the cathode-coated support by a vacuum slurry coating process, heating the same at 80° C/h to 120° C. /h and performing a thermal-treating process at 1200° C. to 1600° C. for 3 hours to 7 hours. There may further be included the step of cooling at 200° C/h to 300° C./h after the thermal-treating process.

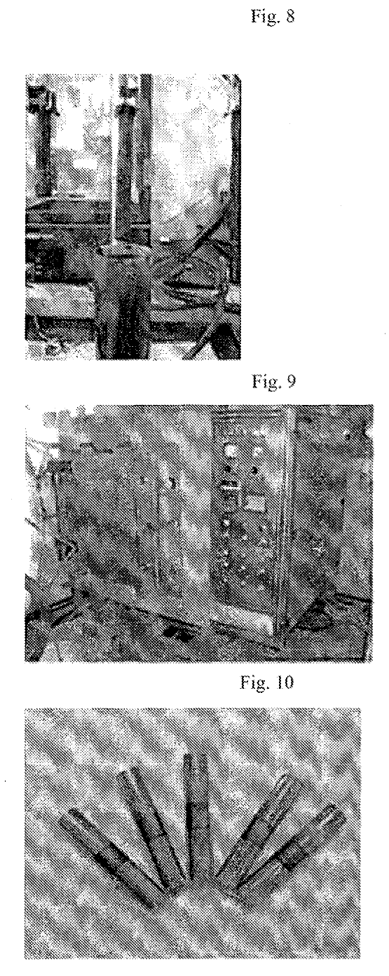

As shown in FIG. 8, the anode is coated on the support coated with the cathode and electrolyte by a dip coating process after coating and thermally treating the electrolyte. As the anode, an anode well known in the art to which the present invention pertains may be used, such as, but not limited to, LSCR-GDC.

After dip-coating the anode, there may be included the steps of heating up at 80° C./h to 120° C./h and thermally treating at 1000° C. to 1300° C. for 2 hours to 4 hours. There may further be included the step of cooling at 200° C./h to 300° C./h after the thermal-treating process.

As shown in FIG. 9, there may further be included a process for reducing the tubular co-electrolyte cell prepared by step 5.

The co-electrolyte cell support prepared by step 5 may be a NIO-YSZ cermet. In order to form a co-electrolysis cell support having good physical properties, such as electric conductivity and strength, the NIO-YSZ cermet is required to be reduced into a type of Nl-YSZ which is then put to use. The reduction process may be performed by treating the tubular co-electrolyte cell prepared in step 5 with hydrogen and nitrogen at 600° C. to 1000° C.

A tubular co-electrolysis cell prepared by the above method may simultaneously electrolyze carbon dioxide and steam together, allowing, for high-efficiency conversion into a syngas fuel, increased durability, and easier high-temperature, pressurizing operation.

### EXAMPLE 1

### Preparing a Tubular Co-Electrolysis Cell

1) Preparing a Support

A mixture powder was obtained by mixing an 8YSZ (8 mol % yttria-stabilized zirconia) powder and a NiO (J. T. Baker Co., USA) powder in a volume ratio of NiO:8YSZ=40:60, and the mixture powder was added with carbon black, ball-milled for uniformization, and then dried and sieved, thereby obtaining a uniform powder.

The prepared NIO/YSZ powder was added with an additive, such as an organic binder, distilled water, plasticizer, or lubrication, and kneaded into a paste that was then extruded and rolling-dried to produce a tubular support.

The support was heated up for ten hours and left at 350° C. for five hours The support was then heated up for five hours and left at 750° C. for three hours, followed by being heated up five hours and left at 1100° C. for three hours to be pre-sintered.

2) Coating a Cathode

The pre-sintered support was dipped into Nl-YSZ to form a cathode, heated up at 100° C./h and left at 1000° C. for three hours, and then cooled down at 250° C./h for thermal treatment.

3) Coating an Electrolyte

The same was coated with an electrolyte using a vacuum slurry coating method, heated up at 100° C./h and left at 1400° C. for five hours, and then cooled down at 250° C./h for thermal treatment.

4) Coating an Anode

After the thermal-treatment, the same was dipped into a YSZ/LSM and LSM composite to form an anode, heated up at 100° C./h and left at 1150° C. for 3 hours, and then cooled down at 250° C./h for thermal treatment.

FIG. 10 illustrates a tubular co-electrolysis cell prepared by the above method. The tubular co-electrolysis cell was formed to have a reaction area of 3 cm².

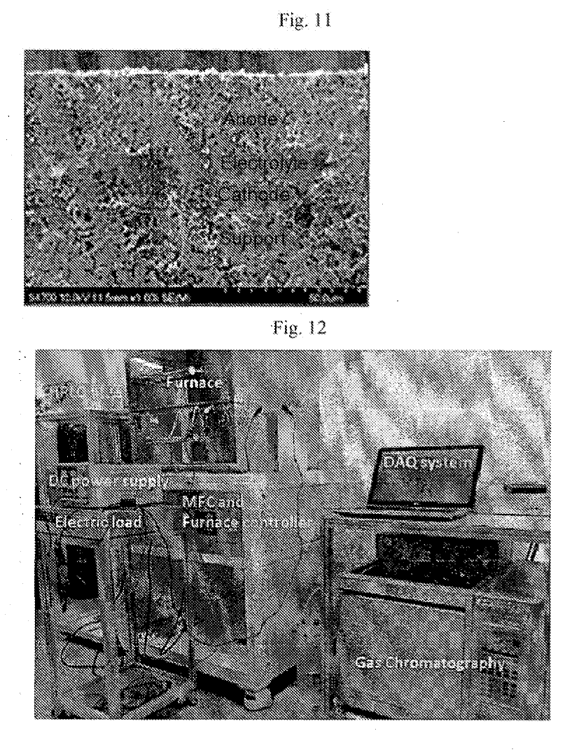

Meanwhile, FIG. 11 illustrates an SEM image of a cross section of the tubular co-electrolysis cell. With reference to FIG. 11, it can be verified that the cathode layer and electrolysis layer prepared by the above method were each 9.92 um thick, and the anode layer was 30.2 um thick.

<Experiment 1> Experiment of Co-Electrolysis at Atmospheric Pressure for a Tubular Co-Electrolysis Cell

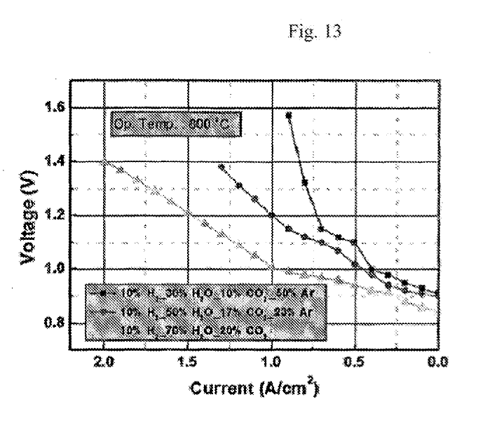

A Ni/Ag wire was used as a current collector for current-collecting the tubular co-electrolysis cell prepared in Example 1 above. As shown in FIG. 12, a co-electrolysis experiment was performed at atmosphere pressure by an atmosphere pressure-type co-electrolysis evaluation system including an HPLC pump, a DC power supply, and a G.C. FIG. 13 illustrates a result of an operation performed at 800° C., 200 cc/min as flow rate for the cathode and anode each.

From the experimental result, it could be verified that as carbon dioxide adds, the over-voltage of the overall reaction decreases. Such result is believed to come from hydrogen and carbon dioxide, added to a fuel and reacting, having participated in a reverse water gas shift (RWGS) reaction.

Although the technical spirit of the present invention has been described with reference to the accompanying drawings, the preferable embodiments of the present invention are provided merely as examples, and the scope of the present invention should not be limited thereto. Rather, it should be appreciated by one of ordinary skill in the art that various changes or derivations may be made thereto without departing from the scope of the present invention.

1. A tubular co-electrolysis cell, comprising:
a cylindrical support including NIO and YSZ;
a cathode layer comprising (Sr₁₋ₓLaₓ)(Ti_{1-y}M_{y})O₃(M=V, Nb, Co, Mn) formed on a surface of the cylindrical support;
a solid electrolyte layer formed on a surface of the cathode layer; and
an anode layer formed on a surface of the solid electrolyte layer.

2. The tubular co-electrolysis cell of claim 1, wherein the solid electrolyte layer comprises one or more selected from the group consisting of YSZ (yttria stabilized zirconia) LSGM (strontium (Sr)- and magnesium (Mg)-doped lanthanium gallate), ScSZ (scandia stabilized zirconium oxide) GDC (gadlinium-doped ceria), and SDC (samaria-doped ceria).

3. The tubular co-electrolysis cell of claim 1, wherein the anode layer comprises a LSCF-GDC or YSZ-LSM and LSM complex.

4. The tubular co-electrolysis cell of claim 1, wherein the anode layer comprises a LSCF-GDC or YSZ-LSM and LSM complex.

5. A method for preparing a tubular co-electrolysis cell, the method comprising:
a step 1 of mixing NIO, YSZ, and a pore forming agent, mixing with a solvent into a type of slurry, and ball-milling the slurry;
a step 2 of drying and then powdering the slurry;
a step 3 of producing a support for the co-electrolysis cell by adding an additive to the powdered mixture and kneading to produce a paste, and extruding the paste;
a step 4 of rolling-drying the extruded support for the co-electrolysis cell; and
a step 5 of pre-sintering the rolling-dried support for the co-electrolysis cell and then coating the support with a cathode, an electrolyte, and an anode,
wherein the cathode comprises a (Sr₁₋ₓLaₓ)(Ti_{1-y}, M_{y})O₃(M=V, Nb, Co, Mn).

6. The method of claim 5, wherein the pore forming agent comprises one or more selected from the group consisting of active carbon and carbon black.

7. The method of claim 5, wherein the additive comprises a binder, a plasticizer, and a lubricant.

8. The method of claim 5, wherein the pre-sintering is performed by stepwise-heating including heating up to 300° C. to 400° C., then to 700° C. to 800° C. and then 1000° C. to 1200° C.

9. The method of claim 5, wherein the cathode and the anode are coated by dip coating.

10. The method of claim 9, wherein the cathode is coated and is then thermally treated at 800° C. to 1200° C.

11. The method of claim 9, wherein the anode is coated and is then thermally treated at 900° C. to 1400° C.

12. The method of claim 5, wherein the electrolyte is coated by vacuum slurry coating.

13. The method of claim 12, wherein the electrolyte is coated and is then thermally treated at 1200° C. to 1600° C.

14. The method of claim 5, wherein a fuel used in the cathode comprises H₂O, CO₂ and H₂.

15. A tubular co-electrolysis cell prepared by the method of claim 5.

16. (canceled)
